(19) United States
(12) Patent Application Publication
(10) Pub. No.: US 2017/0178205 A1
(43) Pub. Date: Jun. 22, 2017

(54) CONSUMER FEEDBACK FOR WEBSITES AND MOBILE APPLICATIONS

(71) Applicant: APPEE PTY LTD, Brisbane, Queensland (AU)

(72) Inventors: Steve John Brandish, Brisbane, Queensland (AU); Skender Kades, Brisbane, Queensland (AU); Nathan Lessels, Brisbane, Queensland (AU); Alberto Mongini, Brisbane, Queensland (AU)

(21) Appl. No.: 15/118,424

(22) PCT Filed: Feb. 12, 2015
(86) PCT No.: PCT/AU2015/050051

§ 371 Date: Aug. 11, 2016

(30) Foreign Application Priority Data
Feb. 12, 2014 (AU) 2014900421
Oct. 10, 2014 (AU) 2014904059

(51) Int. Cl. G06Q 30/02

(52) U.S. Cl. CPC G06Q 30/0282

(57) ABSTRACT

An apparatus for receiving structured user feedback relating to an online or mobile application comprises a data storage unit having stored therein data relating to one or more feedback surveys, one or more options for content to be included in the application and one or more selections. A processor is in communication with the data storage unit and an interface is coupled to be in communication with the processor. Methods performed by the apparatus include configuring an application-specific feedback survey based on the one or more options for content to be included in the application and based on the one or more selections by users accessing the application via a computing device and configuring if and when the feedback survey is presented to users. The configured feedback survey is presented to users accessing the application and feedback from the users is received via the configured feedback survey.

### FIELD OF THE INVENTION

The present invention relates to consumer feedback. In particular, but not exclusively, the present invention relates to electronic systems, methods, apparatus and user interfaces for structuring and obtaining user feedback for websites and mobile applications.

### BACKGROUND TO THE INVENTION

Digital assets, such as websites and mobile phone applications (apps), are a strategic tool for organizations to engage users. This engagement can be to inform, to entertain and/or to promote/conduct sales of goods and/or services, either as an ancillary trade channel or a sole trade channel. As such websites and mobile phone apps are critical to organizations for success in the digital age.

Quantitative “usage” analytics are commonplace within the digital industry and can provide useful insights into usage trends of websites and mobile phone apps. However, there are inadequate “qualitative” analytics currently available across online and mobile platforms to complete the picture relating to why these trends occur.

In order to understand the usability of digital properties, such as websites and mobile phone apps, organizations typically need to engage in costly usability testing studies, which often take a large investment in time and expenditure. These studies are generally against a “test” user base, and are often rudimentary and labour intensive to conduct.

At present, owners of digital properties, such as websites and mobile phone apps, only have fairly inefficient ways of assessing mobile application product feedback. Most of the feedback is in a text form, for example entered by users in contact us/feedback fields, which then has to be interpreted, collated and actioned, or is in the form of simple user ratings. For example, the key product feedback mechanism is still predominantly user reviews, for example provided on the app store, and subjective “star ratings”, based on user intuition and opinion. These processes remain the main mechanisms for feedback and rating of digital properties at present.

Whilst some user feedback facilities are suited to websites, they are not suitable for mobile applications. For example, for user feedback facilities which use text fields allowing users to freely enter their own text, for mobile applications there is only limited space in which users can enter their feedback. This can lead to frustration for users in providing their feedback. Also, as alluded to above, allowing users to freely enter their own text often does not provide focused feedback of the type that is useful to owners of digital properties in developing their digital assets.

Some known feedback facilities only provide the opportunity to provide feedback when the user has encountered a problem with a website, such as a transaction processing problem. Therefore, such feedback is often biased due to the user's very recent, negative experience with the website. Some known feedback facilities only provide the opportunity to provide feedback when the user has completed, or is in the process of completing, a particular process. Therefore, the feedback is limited to being in relation to the particular process. Some known feedback facilities are asynchronous with the users' interaction with the application or website in that providing feedback requires the user to navigate away from the main experience of the application or website. Not only does this reduce participation in providing feedback, but it can be considered annoying and/or obtrusive by users.

### OBJECT OF THE INVENTION

It is a preferred object of the present invention to provide a system and/or a method and/or an apparatus and/or a user interface that addresses or at least ameliorates one or more of the aforementioned problems and/or provides a useful commercial alternative.

### SUMMARY OF THE INVENTION

Generally, embodiments of the present invention relate to systems, methods, apparatus and user interfaces for soliciting and receiving structured user feedback relating to websites (online) and/or mobile applications.

According to one aspect, but not necessarily the broadest aspect, the present invention resides in a method of receiving structured user feedback relating to an online or mobile application, the method comprising:

configuring, by a computer, an application-specific feedback survey based on one or more options for content to be included in the application and based on one or more selections;

configuring, by a computer, if and when the feedback survey is presented to one or more users accessing the application via a computing device;

presenting, via a user interface, the configured feedback survey to the one or more users accessing the application; and

receiving structured feedback from the one or more users via the configured feedback survey.

According to another aspect, but not necessarily the broadest aspect, the present invention resides in an apparatus for receiving structured user feedback relating to an online or mobile application, the apparatus comprising:

a data storage unit having stored therein data relating to one or more feedback surveys, one or more selections and one or more options for content to be included in the application;

a processor coupled to be in communication with the data storage unit; and

an interface coupled to be in communication with the processor to:
configure an application-specific feedback survey based on the one or more options for content to be included in the application and based on the one or more selections; and
configure if and when the feedback survey is presented to one or more users accessing the application via a computing device; wherein the processor:
presents the configured feedback survey to one or more users accessing the application; and
receives structured feedback from the one or more users via the configured feedback survey.

Suitably, the method includes re-configuring the application-specific feedback survey, or configuring a further application-specific feedback survey, based on the structured feedback from the one or more users and presenting a re-configured feedback survey or further feedback survey to a user accessing the application.

Suitably, the re-configured feedback survey or further feedback survey includes options for content to be included in the application seeking further feedback from users.

Suitably, the method includes re-configuring the application based on the structured feedback from the one or more users.

Suitably, the method includes embedding computer implemented code components within native application code of the online or mobile application.

Preferably, the application-specific feedback survey comprises one or more “learning” questions specific to the application.

Suitably, configuring the application-specific feedback survey comprises selecting one or more user interface (UI) elements for inclusion in the feedback survey, each UI element related to an aspect of the website or mobile application upon which feedback from users is to be sought.

Suitably, the re-configured application-specific feedback survey presented to the one or more users includes results of the one or more “learning” questions.

Suitably, the method includes analyzing and/or reporting the results of the structured feedback survey, optionally in real-time.

Suitably, the method includes capturing and storing data relating to usage behaviour, such as, but not limited to one or more of the following: the number of times a user accesses an application, the time spent by the user on the application, the number of updates effected by the user, the number of un-installations of the application, the number of times the application crashes.

Suitably, the method includes modifying the content of the application based on feedback generally referred to as “crowdshaping”, such as “small crowdshaping” and/or “big crowdshaping”.

According to a further aspect, but not necessarily the broadest aspect, the present invention resides in a system for managing the solicitation and receipt of structured user feedback relating to an online or mobile application, the system comprising:

a data storage unit having stored therein data relating to one or more feedback surveys, one or more options for content to be included in the application and one or more selections;

a processor operatively coupled to be in communication with the data storage unit; and

an interface coupled to be in communication with the processor to:
configure an application-specific feedback survey based on the one or more options for content to be included in the application and based on the one or more selections; and
configure if and when the feedback survey is presented to one or more users accessing the application over a communications network via a computing device;

wherein the processor:
presents the configured feedback survey to one or more users accessing the application; and
receives feedback from the one or more users over a communications network via the configured feedback survey.

According to a yet further aspect, but not necessarily the broadest aspect, the present invention resides in a graphical user interface for configuring an application-specific feedback survey relating to an online or mobile application, the graphical user interface coupled to be in communication with a processor and the processor coupled to be in communication with a data storage unit, the data storage unit having stored therein data relating to one or more feedback surveys, one or more options for content to be included in the application and one or more selections, wherein the graphical user interface receives inputs to:

configure an application-specific feedback survey based on the one or more options for content to be included in the application and based on the one or more selections; and

configure if and when the feedback survey is presented to one or more users accessing the application via a computing device;

wherein the processor:

presents the configured feedback survey to one or more users accessing the application; and

receives feedback from the one or more users via the configured feedback survey.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a schematic diagram of a computing device with which embodiments of the present invention are used;

FIG. 2 is a schematic diagram of a system for managing the solicitation and receipt of structured user feedback relating to online or mobile applications according to some embodiments of the present invention;

FIG. 3 illustrates a general flow diagram representing methods according to embodiments of the present invention;

FIGS. 4A-4M are screenshots illustrating examples of a structured feedback survey according to embodiments of the present invention;

FIG. 5A-5M are screenshots illustrating examples of learning questions of a structured feedback survey according to embodiments of the present invention;

FIGS. 6A-6G are screenshots illustrating examples of feedback to users in a structured feedback survey according to embodiments of the present invention;

FIG. 7 shows screenshots illustrating examples of user interfaces of a product owner admin portal according to embodiments of the present invention; and

FIGS. 8-10 show screenshots illustrating further examples of user interfaces of a product owner admin portal according to embodiments of the present invention.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention relate to systems, methods, apparatus and user interfaces for soliciting and receiving structured user feedback relating to websites (online) and/or mobile applications as will be described in detail herein.

Embodiments of the present invention are computer-implemented and use computing devices such as smart phones, laptop computers, personal computers, netbooks, notebooks, personal digital assistants (PDA), tablet PCs having touch sensitive screens, portable multimedia devices, phablets and/or other electronic devices having appropriate known communication capabilities.

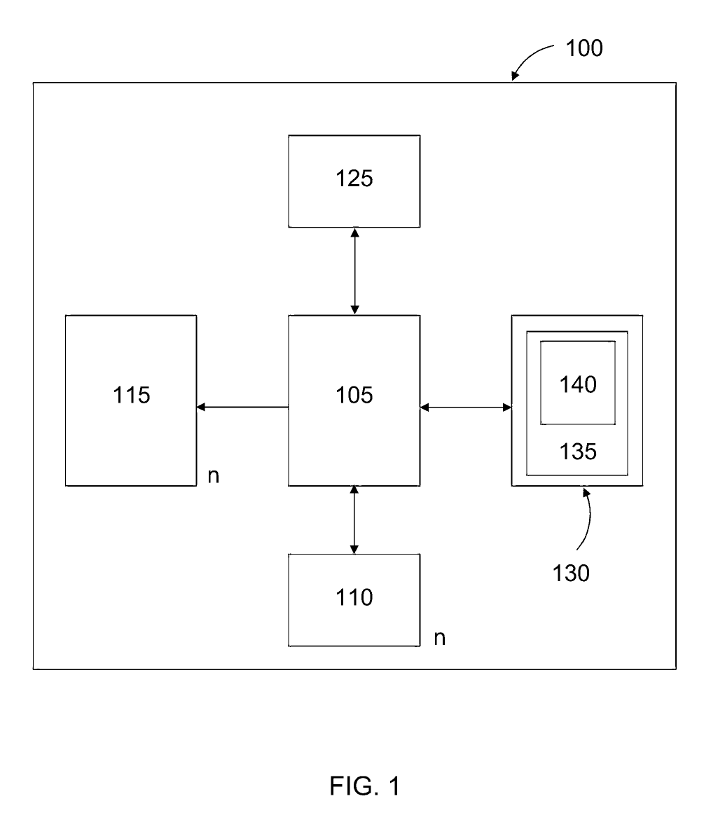

With reference to FIG. 1, a schematic diagram illustrates an example of an apparatus in the form of a computing device 100, such as, but not limited to a smartphone, for use with embodiments of the present invention. The computing device 100 comprises a processor 105 operatively coupled to one or more input devices 110, such as a touch screen, keyboard, controller and/or other suitable input device, such as a mouse where the computing device 100 is in the form of, for example, a laptop computer. Processor 105 is operatively coupled to one or more output devices 115, such as a display screen. It will be appreciated that touch screen 110 can also function as the display screen. A user interface can be displayed on the touch screen 110 to display details relating to an application-specific feedback survey based on one or more options for content to be included in the application and based on the one or more selections, as will be described further herein.

One or more other output devices, such as a printer (not shown) can be coupled to the computing device 100. Computing device 100 can further comprise antenna 125 and/or other well known communication means to enable the computing device 100 to communicate with other computing devices via known wired and/or wireless data connections.

Processor 105 is also operatively coupled to a storage medium in the form of memory 130. Memory 130 comprises a computer readable medium 135, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as are well known in the art. The computer readable medium 135 comprises data and computer readable program code components 140 at least some of which are selectively executed to effect the embodiments of the present invention described herein.

In some embodiments, computer readable program code components can be downloaded to the computing device 100 for embedding in the native computer readable program code components of the website/application which facilitates implementation of embodiments of the present invention.

Persons skilled in the art will appreciate that the computing device 100 comprises other known elements required for the device to perform its known functions, but which are not shown in FIG. 1 and which can vary according to the specific type of computing device.

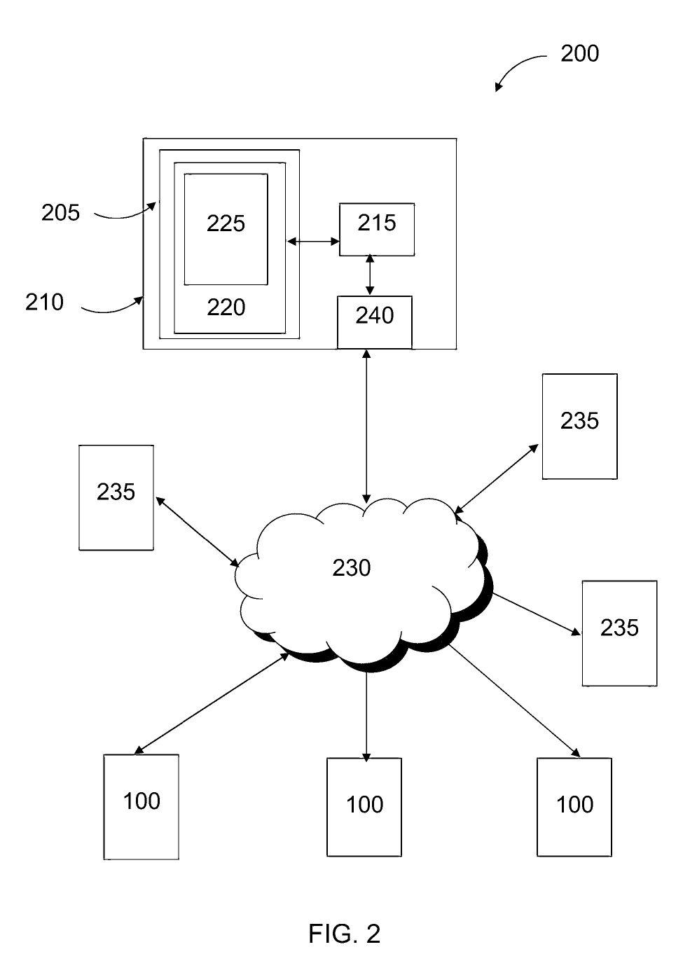

Referring to FIG. 2, a schematic diagram illustrates a system 200 for managing the solicitation and receipt of structured user feedback relating to websites (online) and/or mobile applications in accordance with embodiments of the present invention. The system 200 comprises an apparatus in the form of a data storage unit 210, such as a server, having stored therein data relating to one or more application-specific feedback surveys, each survey based on the one or more options for content to be included in the respective application and based on the one or more respective selections. Other data can include, but is not limited to data analysis and presentation algorithms and software.

The data storage unit 210 comprises a processor 215 operatively coupled to a storage medium in the form of memory 205. Memory 205 comprises a computer readable medium 220, such as those described above in relation to computer readable medium 135. Computer readable medium 220 comprises the aforementioned data. Computer readable medium 220 also comprises computer readable program code components 225 to execute embodiments of the present invention in accordance with the teachings herein. At least some of the computer readable program code components 225 are selectively executed by the processor 215 and are configured to cause the execution of the embodiments of the present invention described herein. Data storage unit 210 also comprises an interface 240 coupled to be in communication with the processor 215 to receive inputs.

The system 200 further comprises one or more computing devices 100 in communication with providers 235 of websites or applications via a communications network 230 via conventional wireless and/or wired connections as are well known in the art. The communications network 230 may be a global communications network, such as the Internet and the computing devices 100 can be any known computing devices as described herein.

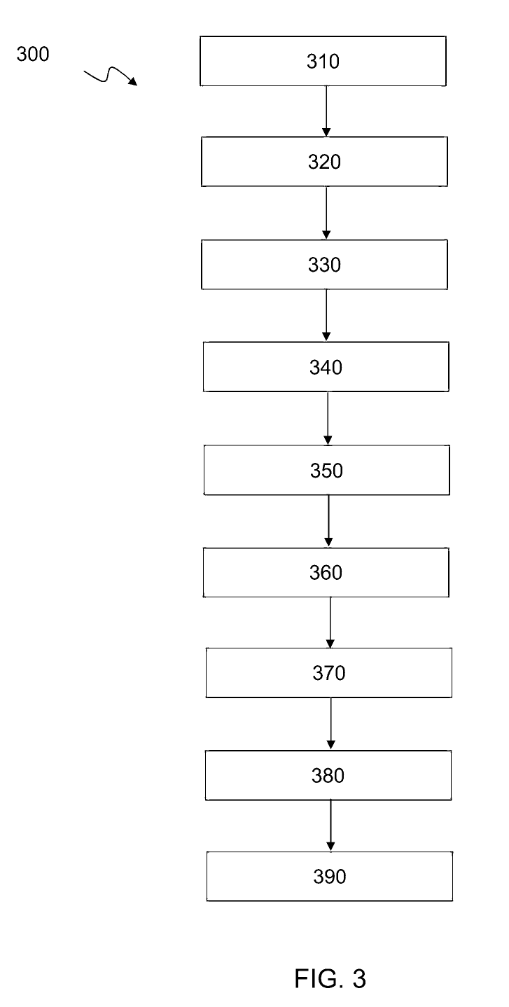

With reference to FIG. 3, some embodiments of the present invention are directed to a method 300 of receiving structured user feedback relating to an online or mobile application. With reference to step 310, embodiments of the method 300 include, for example, a digital product owner completing a registration process on a website or application and the product owner acquiring a user name and password for their account. At step 320, the method includes the product owner purchasing a license for their own website or mobile application. The license can be platform dependent, such as for iOS or Android, or can be platform independent.

The method 300 includes at step 330 presenting the product owner with some computer implemented program code components (e.g. a snippet of proprietary code) to embed within the native code of their application. Once the proprietary code is embedded within their application, embodiments of the present invention can be executed against the product owner's applications.

The method 300 includes at step 340 configuring by a computer an application-specific feedback survey based on one or more options for content to be included in the application and based on one or more selections. For example, when the product owner logs into their account, they are presented with an admin portal view (described further herein) which enables the product owner to select one or more user interface (UI) elements to be included in the feedback survey. The UI elements can be predetermined and/or specific according to the aspect of the website or mobile application upon which the product owner is seeking feedback from users. For example, the UI elements can relate to the main menu/navigation of their product, news items, videos, game centre, subscriber/membership, discounts/offers, statistics, betting, awards etc. or any aspect of the product owner's website or mobile application.

In preferred embodiments, the application-specific feedback survey comprises one or more “learning” questions specific to the application and the UI elements can be selected, or selections made within the UI elements, according to the “learning” questions to be included in the survey.

At 350, the method 300 includes configuring if and when the feedback survey is presented to a user when the user is accessing the application via a computing device 100. Therefore, according to some embodiments, when the feedback survey is published, the user can access the structured questions of the survey when accessing the relevant part, page or section of the product owner's website/application. Hence, the users are being asked specific questions based on the applicable UI element(s) about the product owner's website/application when exposed to the relevant part(s), page(s) or section(s) of the product owner's website/application. However, unlike some of the prior art feedback facilities, the feedback surveys generated and presented in accordance with the present invention are not limited to being presented to a user when a problem with the website/application is encountered or a particular process has been completed or partially completed by the user.

In some embodiments, the feedback survey is presented to a user when the user is accessing any part, page or section or multiple parts/pages/sections of the product owner's website/application. This can be the case when, for example, the feedback survey comprises structured questions applicable to multiple parts/pages/sections of the product owner's website/application. Therefore, the product owner can obtain feedback from users irrespective of the particular part/page/section of the website/application that the user is currently viewing.

The method 300 includes at 360 presenting the configured feedback survey to one or more users accessing the application. The users complete the ‘learning questions” and the method 300 includes at 370 receiving the structured feedback from the one or more users via the configured feedback survey.

Product owners can view a graphical dashboard display of reports/results of the “learning” questions via their web based admin portal in real time. Product owners are then armed with real structured data which validates any of their product assumptions for that particular part/page/section of the website/application to which the UI element related. This will be fed back into the development cycle to iteratively improve the product performance/viability. For example, results of structured feedback are easily viewed to inform usability of the application and further development work. This removes the necessity for separate ‘user-testing’ because feedback can be iterative and ongoing. Also, keeping the data management ‘in-house’ strengthens business capability.

For example, the method 300 can include at 380 re-configuring the application-specific feedback survey, or configuring a further application-specific feedback survey, based on the structured feedback from the one or more users and presenting a re-configured feedback survey, or a further application-specific feedback survey, to a user accessing the application. The re-configured application-specific feedback survey, or further application-specific feedback survey, presented to the one or more users can include the results of the one or more “learning” questions.

The method 300 can also include at 390 re-configuring the application based on the structured feedback from the one or more users. For example, the content and/or the layout of the content of the application can be changed based on the structured feedback from the one or more users.

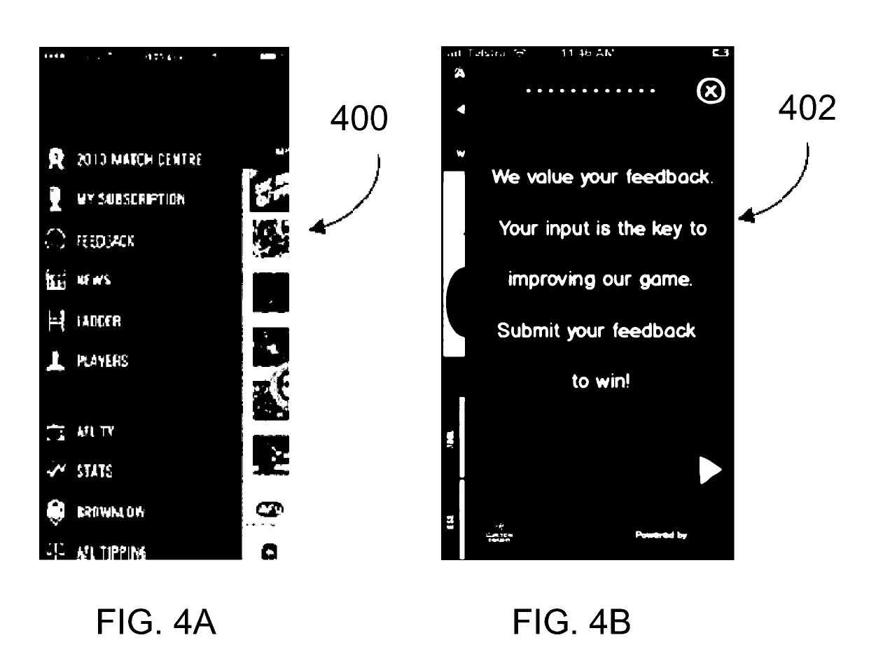

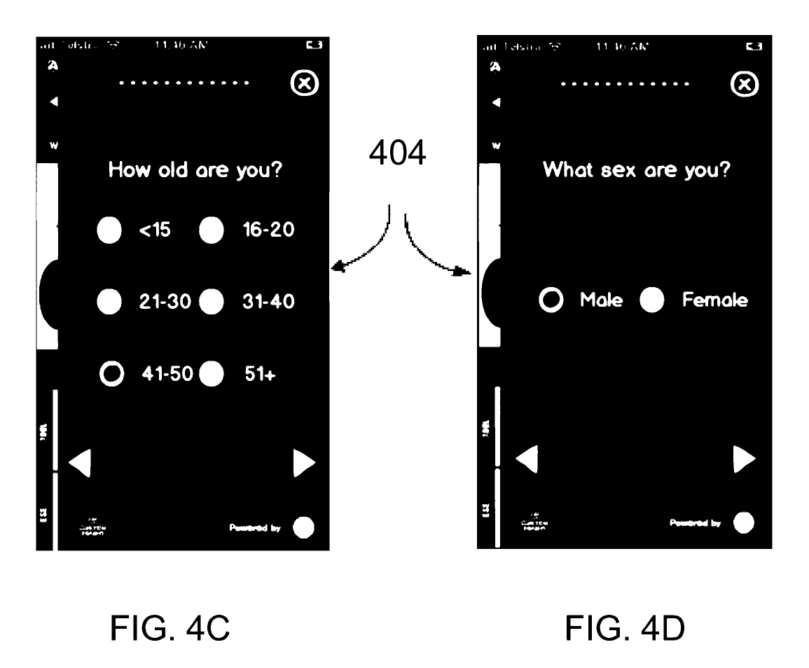

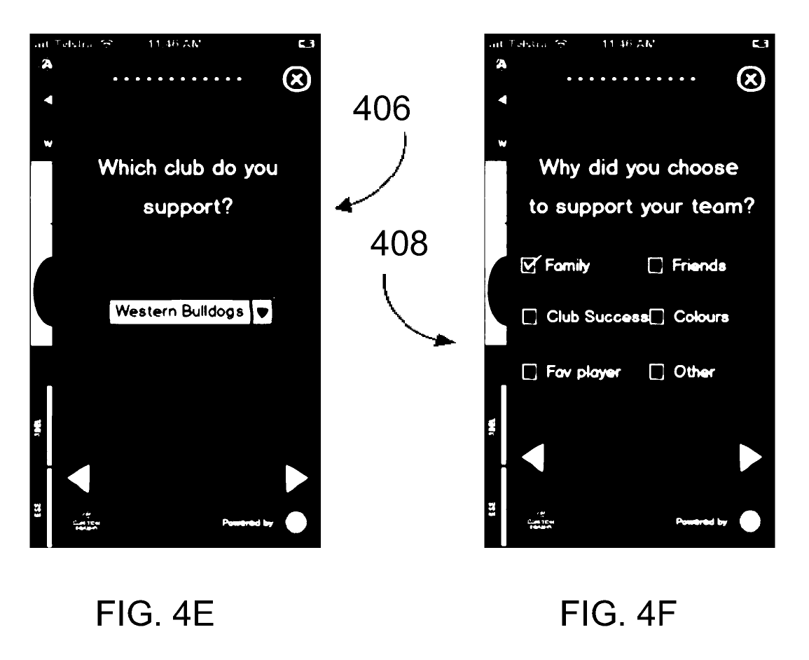

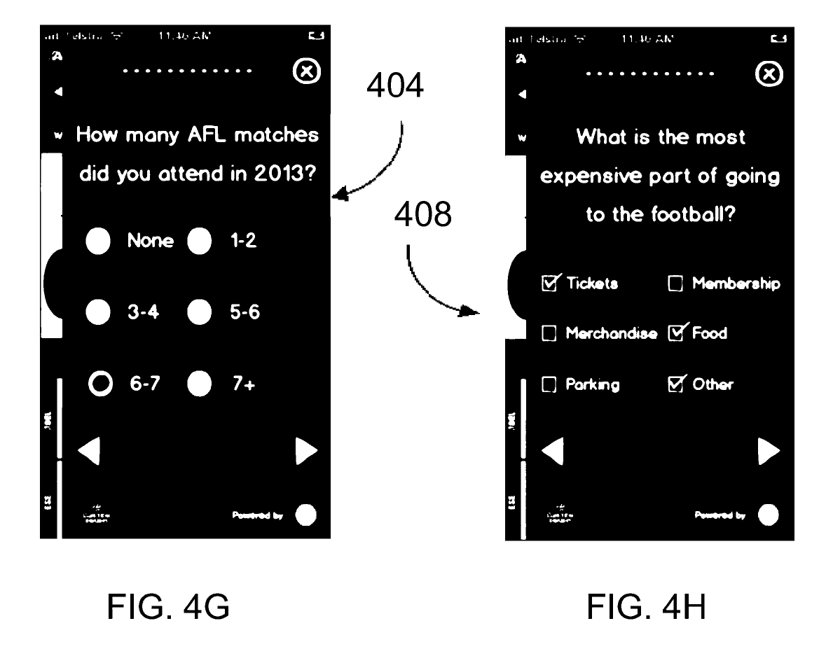

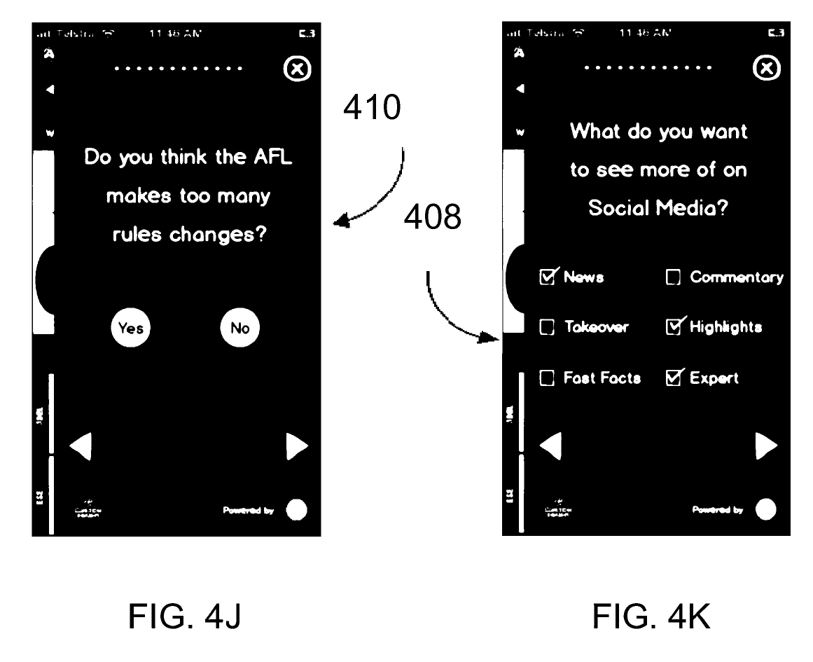

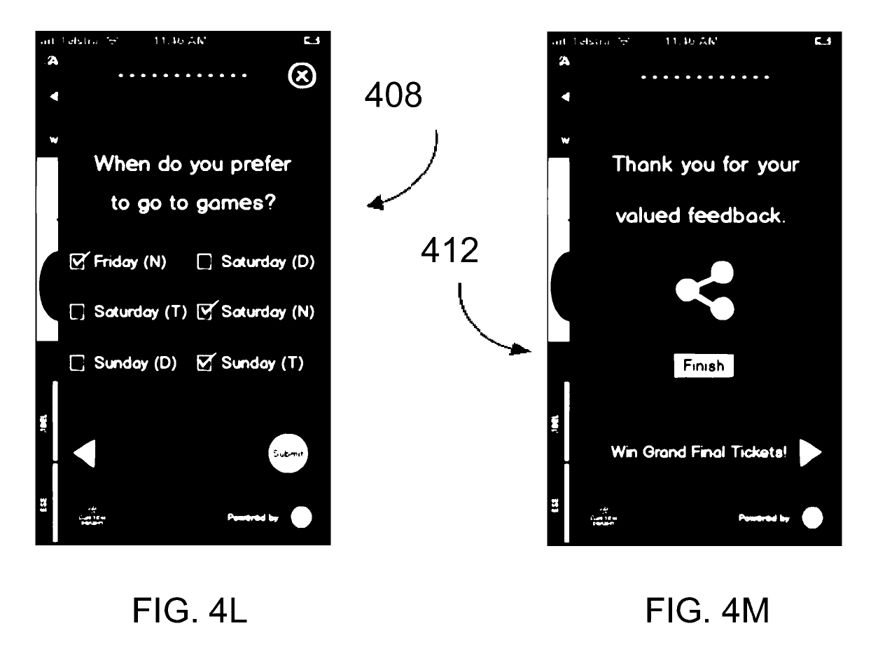

Non-limiting examples of structured user feedback relating to an online or mobile application according to embodiments of the present invention will now be described with reference to screenshots shown in FIG. 4A-FIG. 7.

Referring to FIGS. 4A-4M, screenshots show examples of receiving structured user feedback relating to a mobile sports application. For example, in FIG. 4A a tab or other icon 400, such as a small, unobtrusive glowing tab, is displayed on screen, the selection of which causes a structured user feedback welcome screen 402 to be displayed as shown in FIG. 4B. Alternatively, the welcome screen 402 can automatically be displayed after a predetermined time has elapsed after the application was accessed or after a predetermined period of inactivity, for example of the home screen or any other page of the application. FIGS. 4C, 4D and 4G show examples of “radio” questions 404 where a single option from multiple options can be selected by and received from the user, such as frequency of visits to the site, frequency of visits to matches and the gender of the user. FIG. 4E shows an example of a drop-down menu 406 allowing one of a predetermined number of options to be selected, such as the user's (favourite) team. FIGS. 4F, 4H, 4K and 4L show examples of questions where users can provide input by selecting one or more check boxes 408. FIG. 4J shows an example of a simple yes/no question 410. FIG. 4M shows the conclusion of this part of the structured survey, with an option 412 to enter a competition providing further user engagement and possible reward.

The different types of questions, such as the “radio” questions, drop down menus, check boxes and yes/no questions are examples of different UI elements wherein each UI element is related to an aspect of the website or mobile application upon which feedback from users is to be sought. The UI elements facilitate improved strutted feedback from users. The formulation of the questions and their structure is facilitated by the product owner admin portal described in more detail below with reference to FIG. 7.

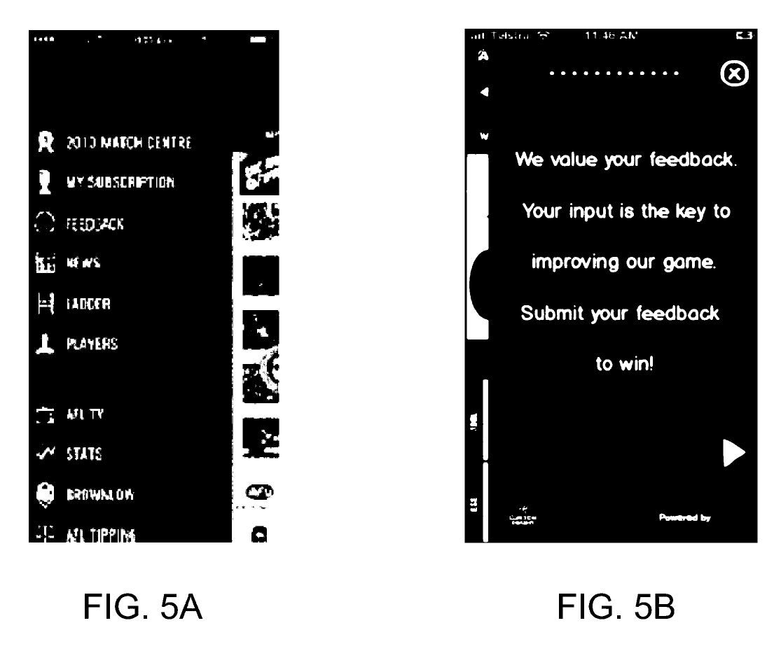

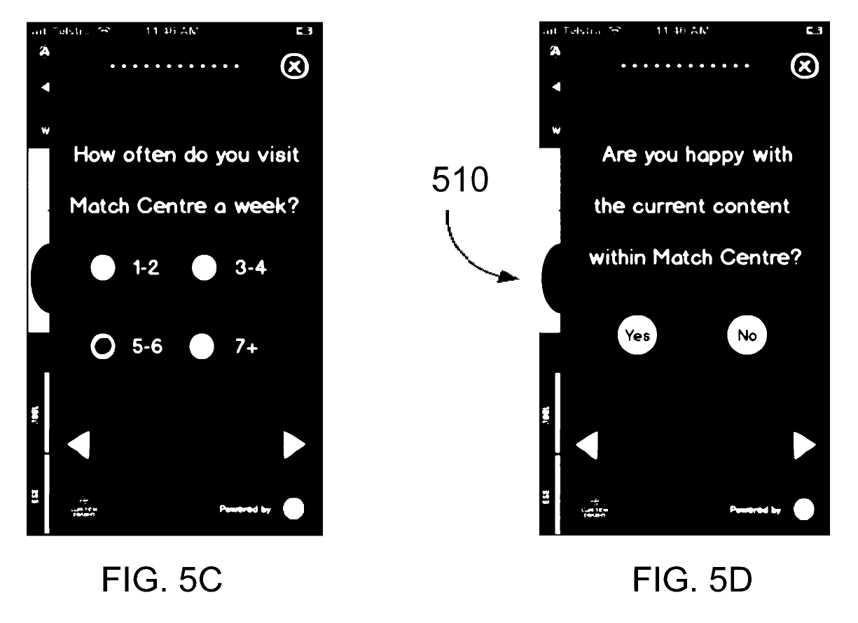

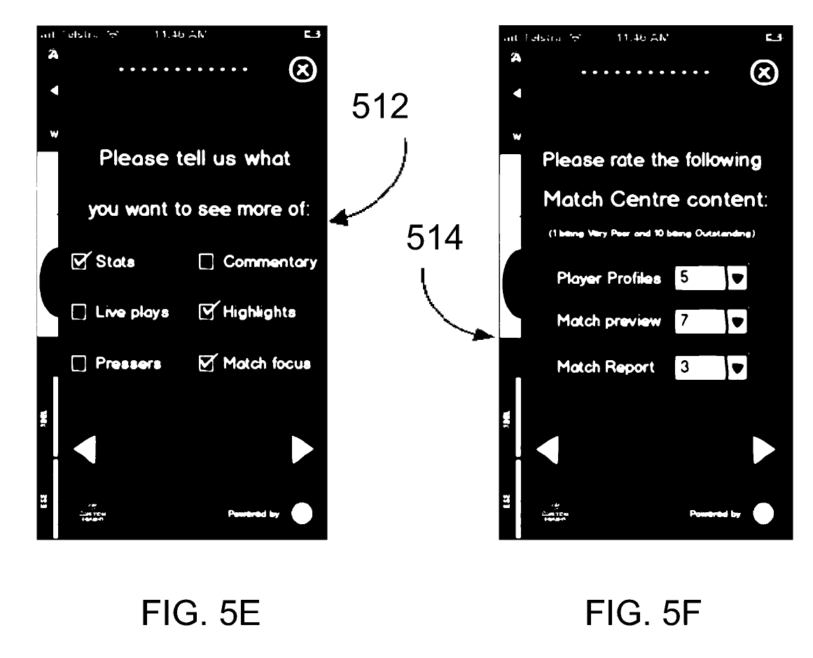

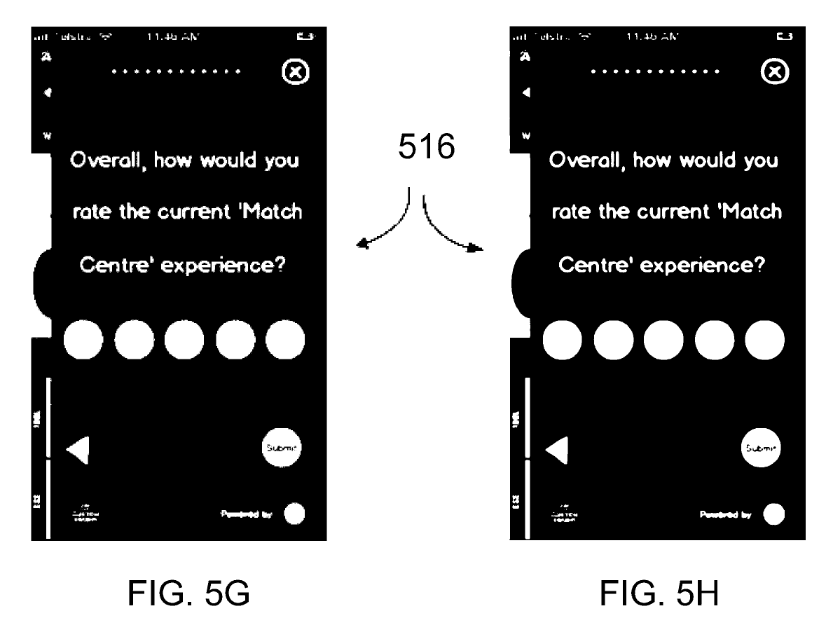

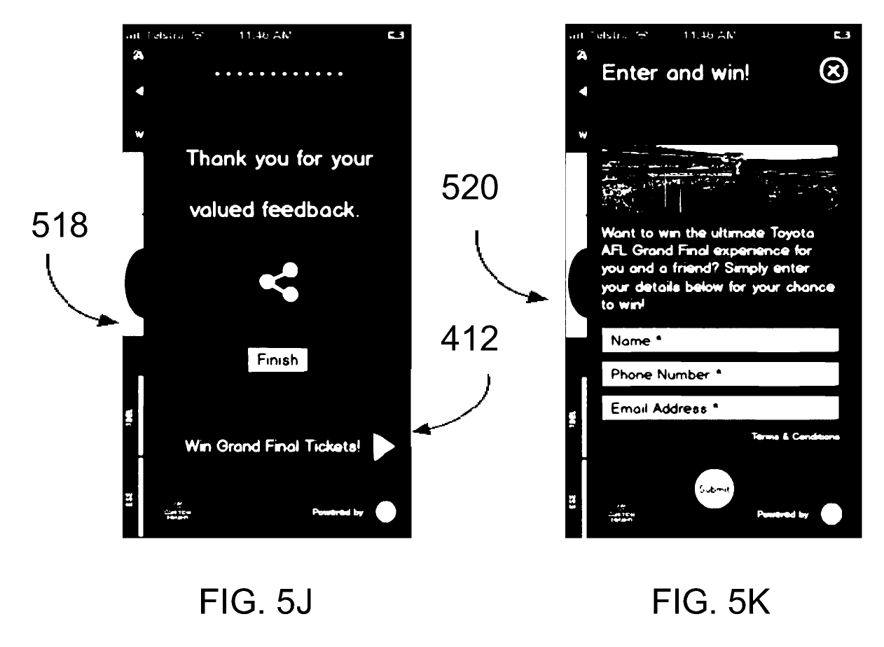

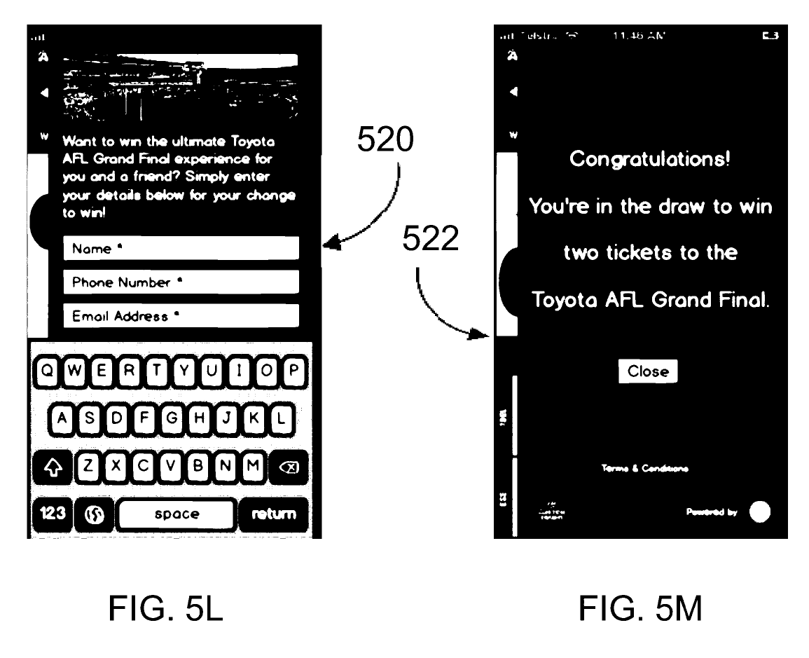

Referring to FIGS. 5A-5M, screenshots show examples of receiving structured user feedback via “learning” questions relating to the mobile sports application referred to in FIGS. 4A-4M. FIG. 5A shows the same output as FIG. 4A and FIG. 5B shows a very similar welcome screen to that shown in FIG. 4B, which is displayed after the structured feedback survey tab or other icon is selected by the user or after a predetermined time has elapsed or after a predetermined period of inactivity. In FIG. 5C, the survey displays the same “radio” question as shown in FIG. 4C, but with fewer options. In FIG. 5D the survey seeks simple approval/disapproval 510 of the current content of the application. In FIG. 5E the survey seeks user feedback regarding content the user wishes to see more of in the application in the form of check boxes 512. In FIG. 5F, the survey seeks ratings 514 from users on specific content of the application via drop-down menus allowing one of a predetermined number of scores to be selected. FIGS. 5G and 5H solicit and receive user feedback in the form of a rating 516 of the user's experience of the application as a whole. FIG. 5J essentially shows the same as FIG. 4M, but with the option to share the feedback. If the competition option 412 shown in FIG. 5J is selected, the screens shown in FIGS. 5K-5M are displayed to the user to receive contact details 520 from the user to enter the competition and display confirmation 522 of entry into the competition.

The formulation of the “learning” questions and their structure is facilitated by the product owner admin portal described in more detail below with reference to FIG. 7. The aforementioned screenshots demonstrate the flexibility provided by embodiments of the present invention in the type, variety and structure of the questions that can be presented to users as part of the feedback survey to solicit specific responses to specific aspects of the website/mobile application.

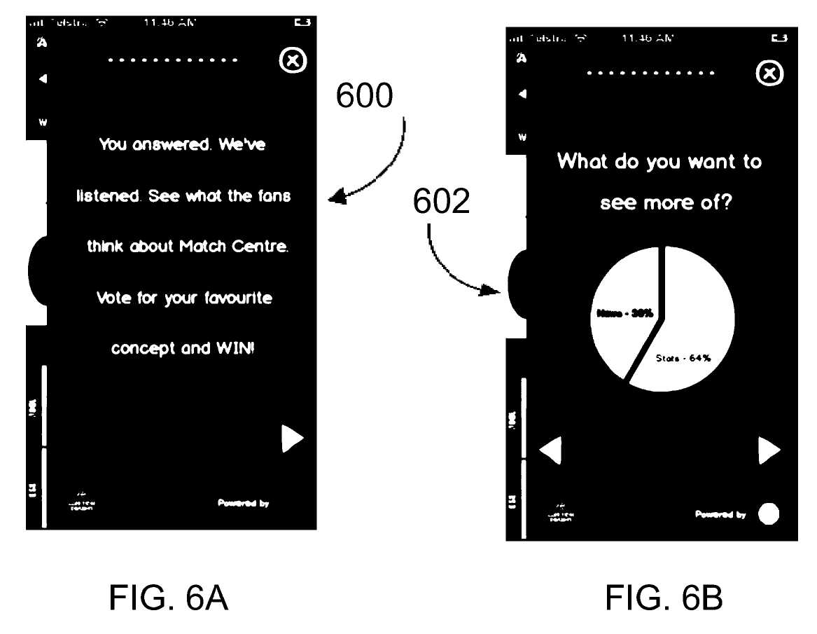

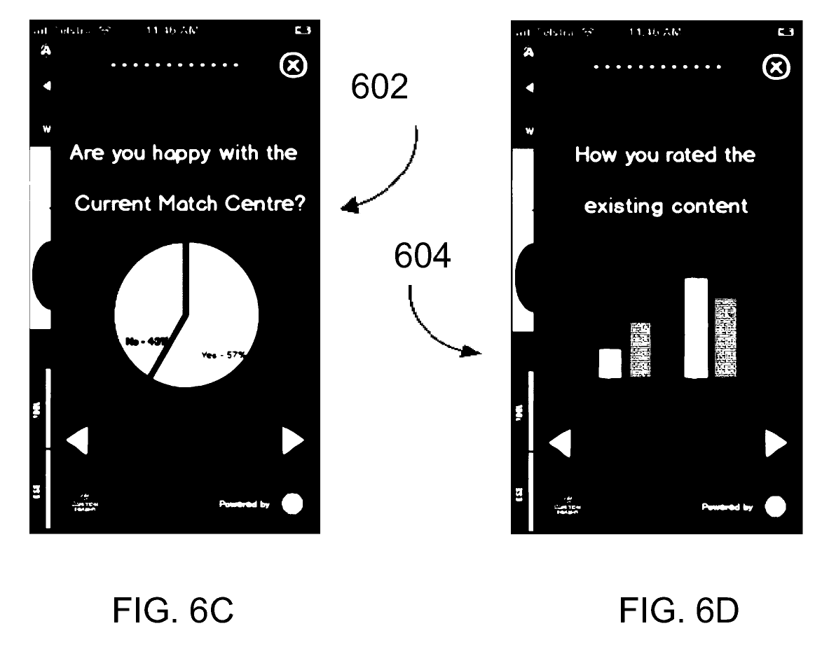

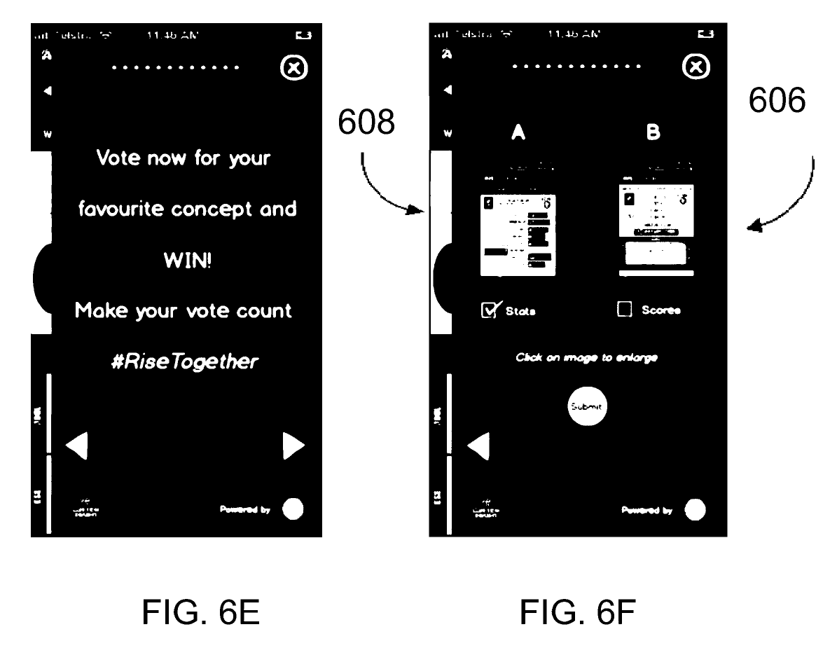

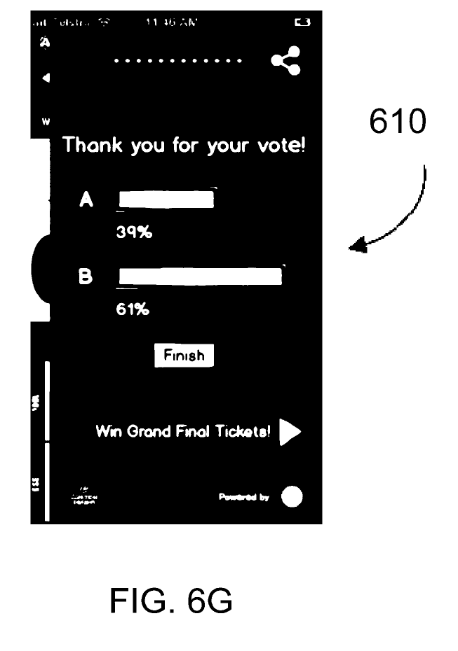

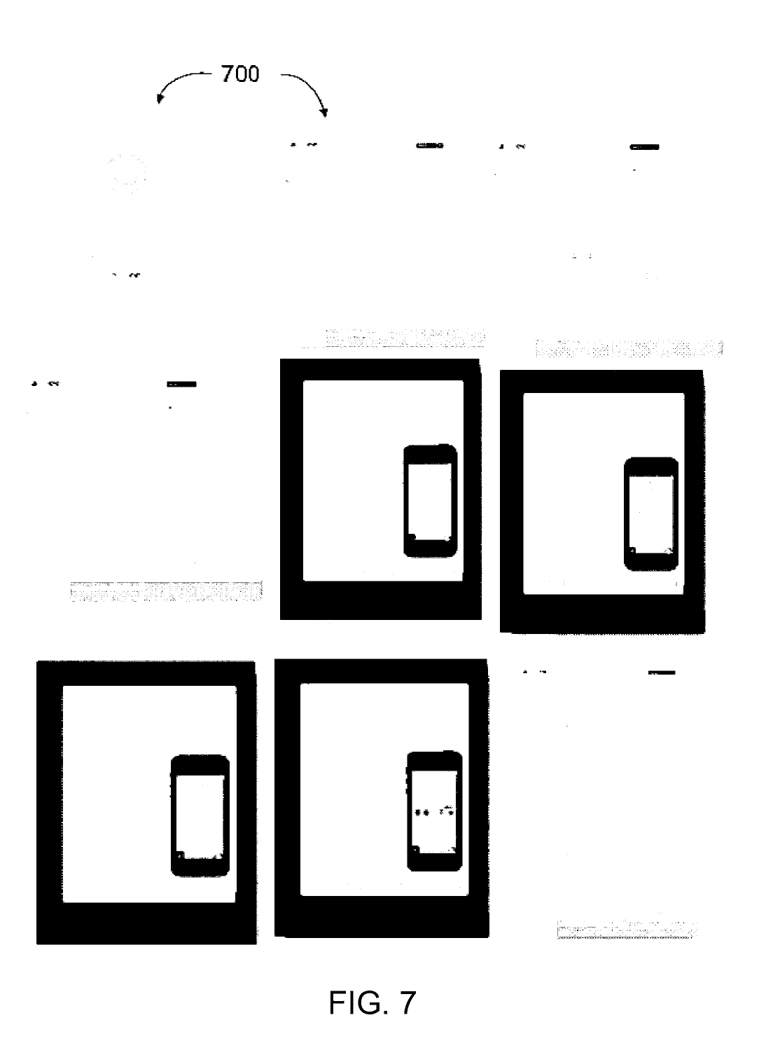

Referring to FIGS. 6A-6G, screenshots show examples of providing the results of user feedback to the users relating to the mobile sports application referred to in FIGS. 4A-4M. The results are provided by a direct feed within a reporting section of the data storage unit 210. FIG. 6A shows a welcome screen 600 for providing the results of user feedback to the users. FIGS. 6B and 6C show the results of collated user feedback in the form of pie charts 602 and FIG. 6D shows the results in the form of a histogram 604, to various questions included in the feedback survey. FIGS. 6E and 6F invite further feedback from users by inviting users to vote on two alternative possible future concepts and content 606 to be included in the application via selection of one of the check boxes 608. It will be appreciated that in other embodiments more than two options for future concepts and content for the application can be presented to users and users can be allowed to vote for one or more options and/or rate the options in their order of preference. This is an example of the results of the structured feedback survey being presented to the users of the website/application and influencing the development and evolution of the application. Real time polling 610 of the results of content 606 to be included in the application is shown in FIG. 6G.

Referring to FIG. 7, various screenshots show examples of a product owner admin portal 700 that enables a digital product owner to configure the UI elements according to the questions to be asked in the structured feedback survey and the format and number of the response options. The admin portal 700 thus enables product owners to formulate particular questions regarding specific aspects of the online or mobile application and limit the scope of responses via the format and/or number of the response options. The product owner admin portal 700 also enables the product owner to view in real time reports and statistics, numerically and/or graphically, relating to one or more feedback surveys relating to one or more websites and/or mobile applications and manage account matters. For example, reporting capabilities of the admin portal 700 can include the comparison of multiple applications, e.g. owned by the same or different organizations against a common set of metrics to assist with executive decision making such as budget allocation and development.

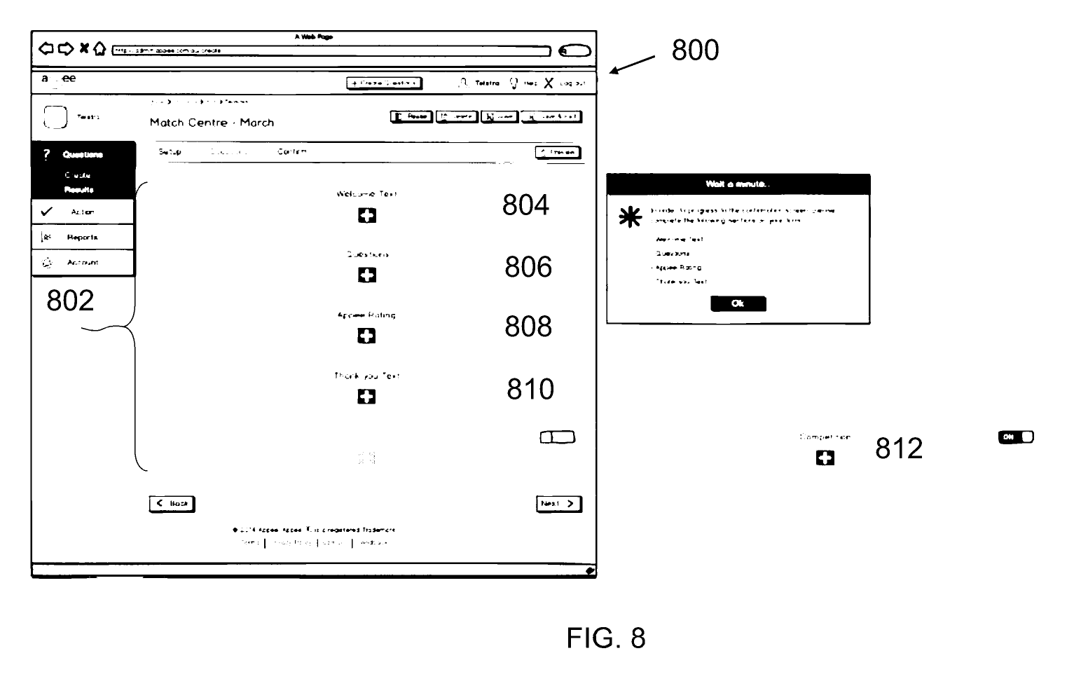

FIG. 8 is a screenshot showing a user interface 800 of the owner admin portal 700 in which the product owner can create questions for the feedback survey. In some embodiments, user interface 800 is in the form of a graphical user interface. This includes different survey creation modules 802 relating to the welcome screen 804, various types of questions 806, a rating section 808, a thank you message 810 and a competition section 812, as described above.

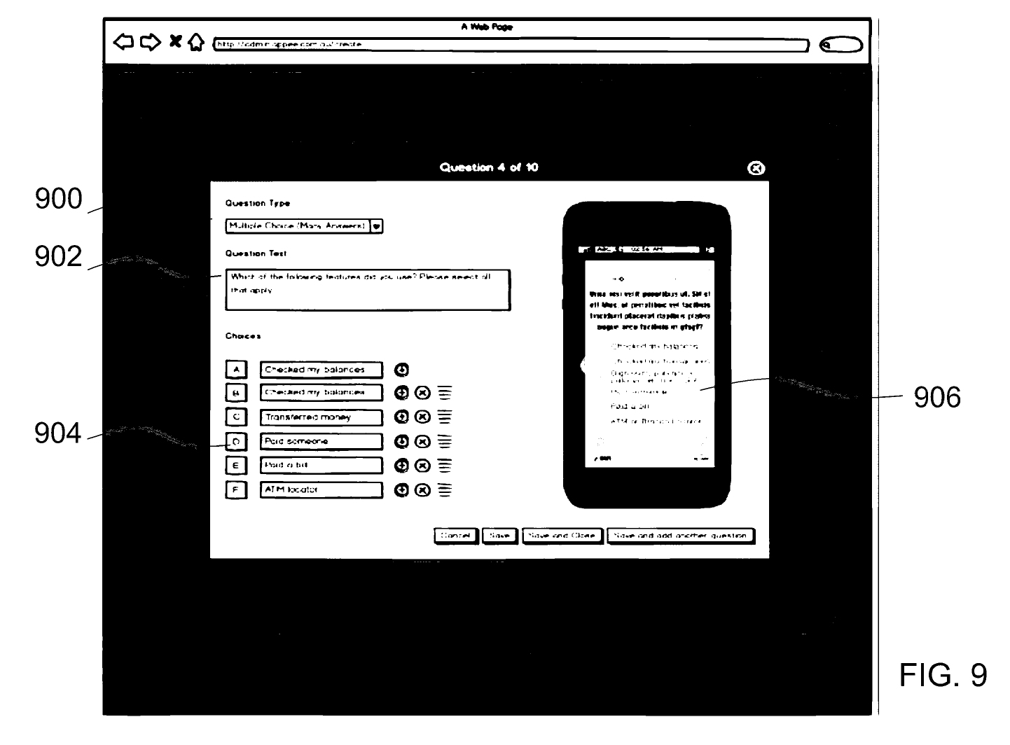

FIG. 9 is a screenshot showing the user interface of the owner admin portal 700 with further details relating to question creation. The user interface includes a menu 900 to select the format of questions required, such as multiple choice with many answers, as shown in FIG. 9, yes/no, dropdown ratings etc. The administrator can then draft their question in the Question Text window 902, formulate the possible choices 904, e.g. A to E, and preview 906 how the question will be displayed all within the same UI. The example shown in FIG. 9 is an example of a feedback survey for a banking related application.

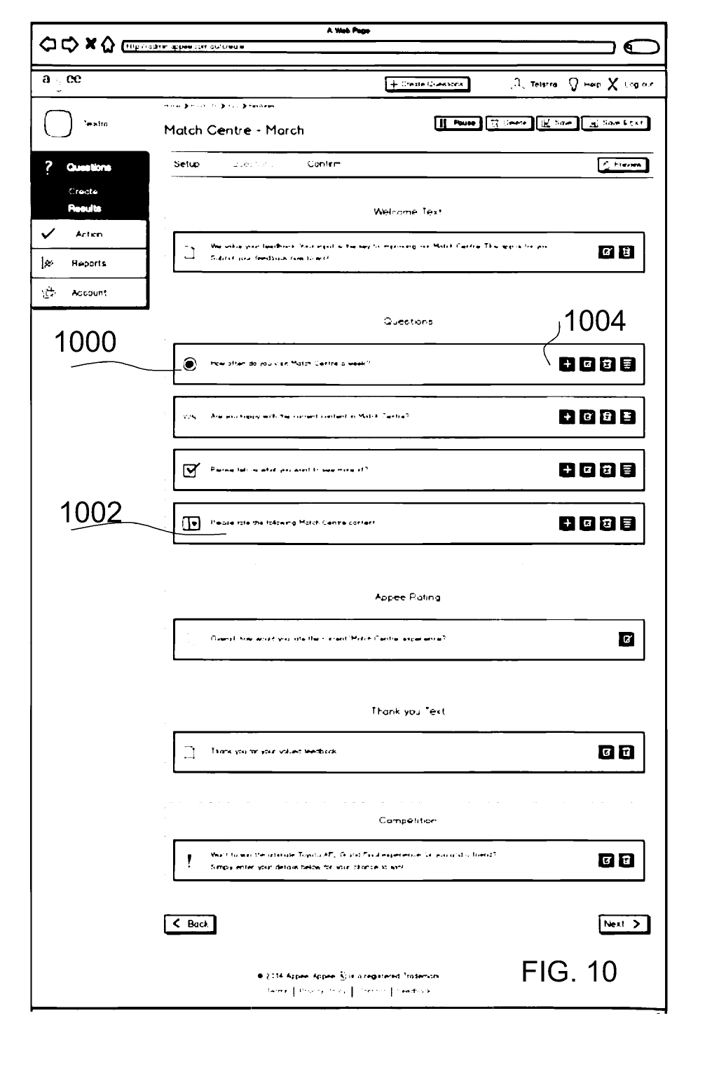

FIG. 10 is another screenshot of the user interface of the owner admin portal 700 showing further details relating to creation of feedback surveys. This aspect of the UI provides a summary of the content of the different sections of the feedback survey in each of the survey creation modules 802 referred to in relation to FIG. 8. In relation to each question, the summary UI displays an icon 1000 indicating the type of question, such as multiple choice, yes/no etc., the question being asked or part thereof 1002 and icons 1004 allowing different actions to be effected in relation to the questions, such as viewing how the question will be displayed in the feedback survey, editing the question, deleting the question etc.

According to some embodiments of the present invention, questions in the feedback survey can include one or more Net Promoter Score (NPS®) type questions to determine which users of the application are promoters, passives or detractors. Responses to such questions can be stored and correlated with other feedback to modify the content of the application.

According to some embodiments of the present invention, questions in the feedback survey can include one or more agile user stories, such as “As a user, I would like to . . . ”, which solicits feedback from users regarding what content and/or functionality they would like to experience in the application. Responses to such questions can be stored and correlated with other feedback to modify the content of the application.

Embodiments of the present invention can also include capturing and storing data relating to usage behaviour, such as, but not limited to the number of times a user accesses an application, the time spent by the user on the application, the number of updates effected by the user, the number of un-installations of the application, the number of times the application crashes and the like. This type of feedback can also inform and influence the content of the application by indicating, for example, the more and less popular sections of the application, the popularity and/or performance of the application. Other captured information can include the type of platform being used, e.g. iOS or Android.

Embodiments of the present invention can include modifying the content of applications based on feedback generally referred to as “crowdshaping”.

“Small crowdshaping” involves shaping and reshaping the application or service in real-time around the preferences of the users of the application or service in a, typically, small area, such as an office, a restaurant, or on a plane. Small crowdshaping enables the application or service to have increased relevance to the user via the accommodation of their preferences.

“Big crowdshaping” involves intelligently shaping and reshaping the application or service based on the aggregated data on the preferences or behaviour of large numbers of users. Users receive a more functional, efficient application or service shaped or re-shaped by the way users really behave or interact with the application. This can be achieved via the passive sharing of their data.

Embodiments of the present invention thus provide a new type of management tool that provides owners of digital assets, such as websites and mobile applications, with structured feedback which can be analysed to assist owners in developing their digital assets to improve performance, profitability and/or meet consumer demands. Embodiments of the present invention enable owners of digital assets to configure an application-specific feedback survey based on one or more options for content to be included in the application and based on one or more selections. Owners can configure if, when and how the feedback survey is presented to a user to solicit and receive the feedback for subsequent analysis to, for example, validate their assumptions about the design and/or functionality of their digital assets.

Embodiments of the present invention increase the productivity of digital properties by providing targeted questions formulated via the UI elements, allowing product owners to lead the feedback topics and obtain the answers relevant to particular aspects of their website and/or mobile application and aligned with their business objectives. The feedback survey is accessed via the website and/or mobile application to which it relates ensuring that responses are being obtained from relevant users with real experience of the website and/or mobile application. This obviates the difficulties in recruiting relevant participants often encountered with conventional usability testing.

By including options for content to be included in the application upon which users can vote and presenting users with the results of their feedback, embodiments of the present invention provide product owners with accurate feedback on real and relevant content and clear direction on how to improve their website and/or mobile application which has a better likelihood of being successful. Embodiments of the present invention also generate goodwill with users of the website and/or mobile application because users feel they are being listened to and can see changes to the website/mobile application in accordance with their feedback opinions.

Feedback surveys according to the present invention are presented to users in a synchronous and unobtrusive way thus increasing the likelihood of participation by users and minimizing the risk of annoying users by detracting them from the main app experience.

Embodiments of the present invention enable organisations to directly and immediately engage with their users without the need for an intermediary survey organization or user testing to interpret, collect or aggregate data. Once the code snippet is installed, the simple configurability of the feedback campaign and the real time reporting can enable even a CEO to ask questions directly to and receive response from its customers.

Embodiments of the present invention provide the possibility to “brand” a campaign, thus enabling another monetization channel to owners of digital properties. For example, organisations or brands that may not have their own “popular application”, but by using the successful application of an affiliate or the like, feedback can be solicited and received on the products/ads of the organisation without the “popular application”.

Embodiments of the present invention thus contribute to the economic benefit of each country in which the invention is implemented. Further, embodiments of the present invention described herein comprise a mode or manner of achieving an end result which is an artificially created state of affairs of utility in the field of economic endeavour.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1. A method of receiving structured user feedback relating to an online or mobile application, the method comprising:
configuring, by a computer, an application-specific feedback survey based on one or more options for content to be included in the application and based on one or more selections;
configuring, by a computer, if and when the feedback survey is presented to one or more users accessing the application via a computing device;
presenting, via a user interface, the configured feedback survey to one or more users accessing the application; and
receiving feedback from the one or more users via the configured feedback survey.

2. The method of claim 1, wherein configuring the application-specific feedback survey comprises selecting one or more “learning” questions specific to the application.

3. The method of claim 2, wherein configuring the application-specific feedback survey comprises selecting one or more user interface (UI) elements for inclusion in the feedback survey, each UI element related to an aspect of the website or mobile application upon which feedback from users is to be sought.

4. The method of claim 1, further including re-configuring the application-specific feedback survey based on the structured feedback from the one or more users and presenting a re-configured application-specific feedback survey to a user accessing the application.

5. The method of claim 1, further including configuring a further application-specific feedback survey based on the structured feedback from the one or more users and presenting the further application-specific feedback survey to a user accessing the application.

6. The method of claim 5, wherein the re-configured application-specific feedback survey, or the further application-specific feedback survey, presented to the one or more users includes results of the one or more “learning” questions specific to the application

7. The method of claim 6, wherein the re-configured feedback survey, or the further feedback survey, includes options for content to be included in the application and seeks further feedback from users.

8. The method of claim 1, further including re-configuring the application based on the structured feedback from the one or more users.

9. The method of claim 1, further including one or more of the following: embedding computer implemented code components within native application code of the online or mobile application; analyzing and/or reporting the results of the structured feedback survey in real-time; capturing and storing data relating to usage behaviour.

10. (canceled)

11. (canceled)

12. The method of claim 9, wherein the usage behaviour is selected from one or more of the following: the number of times a user accesses an application; the time spent by the user on the application; the number of updates effected by the user; the number of un-installations of the application; the number of times the application crashes.

13. The method of claim 1, including modifying the content of the application based on feedback generally referred to as “crowdshaping”, wherein the “crowdshaping” is in the form of one or more of the following: “small crowdshaping”; “big crowdshaping”.

14. (canceled)

15. An apparatus for receiving structured user feedback relating to an online or mobile application, the apparatus comprising:
a data storage unit having stored therein data relating to one or more feedback surveys, one or more options for content to be included in the application and one or more selections;
a processor coupled to be in communication with the data storage unit; and
an interface coupled to be in communication with the processor to:
configure an application-specific feedback survey based on the one or more options for content to be included in the application and based on the one or more selections; and
configure if and when the feedback survey is presented to one or more users accessing the application via a computing device;
wherein the processor:
presents the configured feedback survey to one or more users accessing the application; and
receives feedback from the one or more users via the configured feedback survey.

16. The apparatus of claim 15, wherein the application-specific feedback survey comprises one or more “learning” questions specific to the application.

17. The apparatus of claim 16, wherein the application-specific feedback survey comprises one or more user interface (UI) elements, each UI element related to an aspect of the website or mobile application upon which feedback from users is to be sought.

18. The apparatus of claim 15, wherein the processor re-configures the application-specific feedback survey based on the structured feedback from the one or more users and presents a re-configured application-specific feedback survey to a user accessing the application.

19. The apparatus of claim 15, wherein the processor configures a further application-specific feedback survey based on the structured feedback from the one or more users and presents the further application-specific feedback survey to a user accessing the application.

20. The apparatus of claim 19, wherein the processor includes results of the one or more “learning” questions in the re-configured application-specific feedback survey, or the further application-specific feedback survey, presented to the one or more users.

21. The apparatus of claim 20, wherein the processor includes options for content to be included in the application and seeks further feedback from users in the re-configured feedback survey, or the further feedback survey.

22. The apparatus of claim 15, wherein the processor re-configures the application based on the structured feedback from the one or more users.

23. The apparatus of claim 15, wherein the processor performs one or more of the following: embeds computer implemented code components within native application code of the online or mobile application; analyzes and/or reports the results of the structured feedback survey in real-time; captures and stores data relating to usage behaviour.

24. (canceled)

25. (canceled)

26. The apparatus of claim 23, wherein the usage behaviour is selected from one or more of the following: the number of times a user accesses an application; the time spent by the user on the application; the number of updates effected by the user; the number of un-installations of the application; the number of times the application crashes.

27. The apparatus of claim 15, wherein the processor modifies the content of the application based on feedback generally referred to as “crowdshaping”, wherein the “crowdshaping” is in the form of one or more of the following: “small crowdshaping”; “big crowdshaping”.

28. (canceled)

29. A system for managing the solicitation and receipt of structured user feedback relating to an online or mobile application, the system comprising:
a data storage unit having stored therein data relating to one or more feedback surveys, one or more options for content to be included in the application and one or more selections;
a processor operatively coupled to be in communication with the data storage unit; and
an interface coupled to be in communication with the processor to:
configure an application-specific feedback survey based on the one or more options for content to be included in the application and based on the one or more selections; and
configure if and when the feedback survey is presented to one or more users accessing the application over a communications network via a computing device;
wherein the processor:
presents the configured feedback survey to one or more users accessing the application; and
receives feedback from the one or more users over a communications network via the configured feedback survey.

30. A graphical user interface for configuring an application-specific feedback survey relating to an online or mobile application, the graphical user interface coupled to be in communication with a processor and the processor coupled to be in communication with a data storage unit, the data storage unit having stored therein data relating to one or more feedback surveys, one or more options for content to be included in the application and one or more selections, wherein the graphical user interface receives inputs to:
configure an application-specific feedback survey based on the one or more options for content to be included in the application and based on the one or more selections; and
configure if and when the feedback survey is presented to one or more users accessing the application via a computing device;
wherein the processor:
presents the configured feedback survey to one or more users accessing the application; and
receives feedback from the one or more users via the configured feedback survey.
